(19) United States
(12) Patent Application Publication
(10) Pub. No.: US 2005/0178859 A1
(43) Pub. Date: Aug. 18, 2005

(54) Fuel injector for an internal combustion engine

(75) Inventor: Takaharu Sako, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/047,703

(22) Filed: Feb. 2, 2005

(30) Foreign Application Priority Data
Feb. 13, 2004 (JP) 2004-37224

(51) Int. Cl. F02M 41/16

(52) U.S. Cl. 239/533.9; 239/96

(57) ABSTRACT

A fuel injector for an internal combustion engine includes a nozzle body, a needle, a control piston and a force disperser. The nozzle body has a valve seat for starting and stopping fuel injection. The needle is slidably disposed in the nozzle body and has a valve head for seating on the valve seat. The control piston is for transmitting a drive force to the needle. The force disperser disperses the drive force when the needle displaces a predetermined distance relative to the nozzle body. The force disperser provides for an elastic deformation of at least one of the nozzle body and the needle to prevent concentration of the drive force on the valve seat and the valve head.

### CROSS REFERENCE TO RELATED APPLICATION

This application is based upon and claims the benefit of priority of Japanese Patent Application No. 2004-037224 filed on Feb. 13, 2004, the content of which is incorporated herein by reference.

### FIELD OF THE INVENTION

The present invention relates to a fuel injector for injecting fuel into a cylinder of an internal combustion engine and, more particularly, to a fuel injector having a force disperser capable of dispersing a drive force away from a valve seat.

### BACKGROUND OF THE INVENTION

U.S. Patent Application No. U.S. 2003/0052202A1 (JP2003-166457A) discloses a conventional fuel injector for injecting fuel into cylinders of a common rail-type fuel injection system for an internal combustion engine such as a diesel engine. This type of fuel injector includes a nozzle body having injection holes for injecting fuel, a needle disposed in the nozzle body for longitudinal reciprocation to open and close the injection holes, a nozzle holder retaining the nozzle body, and a control piston disposed in the nozzle holder for longitudinal reciprocation to directly or indirectly actuate the needle (refer to FIG. 4).

This above-described fuel injector has a fuel seal structure for providing a valve for tightly closing the injection holes by applying a force of the control piston to the needle, thereby forcing the needle onto a seat of the valve. A high-pressure fuel in a pressure control chamber generates the driving force of the control piston. The pressure of the high-pressure fuel is increased and decreased by opening and closing an electromagnetic valve.

The conventional fuel injector is effective for providing a tight seal to the valve for closing the injection hole. However, the high-pressure fuel may wear the seat of the valve via an excessive force applied by the needle.

### SUMMARY OF THE INVENTION

An object of the present invention is to provide a fuel injector for an internal combustion engine that controls a control piston disposed in a nozzle holder for longitudinal reciprocation to directly or indirectly actuate a needle for opening and closing a valve located just upstream of injection holes without applying an excessive valve-seating pressure.

Another object of the present invention is to provide a fuel injector to control a control piston disposed in a nozzle holder for longitudinal reciprocation to directly or indirectly actuate a needle for opening and closing a valve located just upstream of injection holes without applying an excessive valve-seating pressure such that any change in a fuel injection amount caused by wear of the valve is limited.

To achieve the above objects, the fuel injector according to the present invention includes a nozzle body, a needle, a control piston and a force disperser. The nozzle body has a valve seat for starting and stopping fuel injection. The needle is slidably disposed in the nozzle body and has a valve head for engaging the valve seat. The control piston transmits a drive force to the needle. The force disperser disperses the drive force when the needle displaces a predetermined distance relative to the nozzle body. The force disperser provides for an elastic deformation of at least one of the nozzle body and the needle to reduce the amount of the drive force concentrated on the valve seat and the valve head.

### BRIEF DESCRIPTION OF THE DRAWINGS

Other features and advantages of the present invention will be appreciated, as well as methods of operation and the function of the related parts, from a study of the following detailed description, the appended claims, and the drawings, all of which form a part of this application. In the drawings:

FIG. 1 is a partial cross-sectional side view of a nozzle portion of a fuel injector according to a first embodiment of the present invention;

FIG. 2 is a cross-sectional view of the fuel injector according to the first embodiment of the present invention;

FIG. 3 is a partial cross-sectional side view of a nozzle portion of a fuel injector according to a second embodiment of the present invention; and

FIG. 4 is a partial cross-sectional side view of a nozzle portion of a conventional fuel injector.

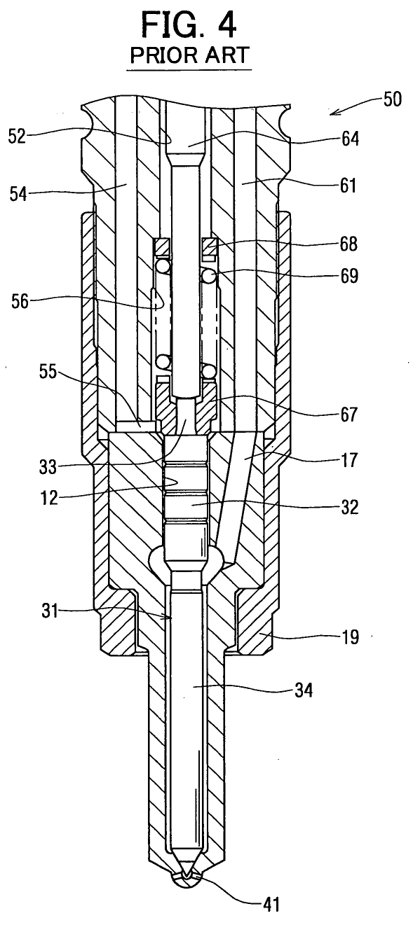

### DESCRIPTION OF THE PREFERRED EMBODIMENTS

Each of the fuel injectors described in the embodiments below are applied to a common rail-type fuel injection system for a diesel engine.

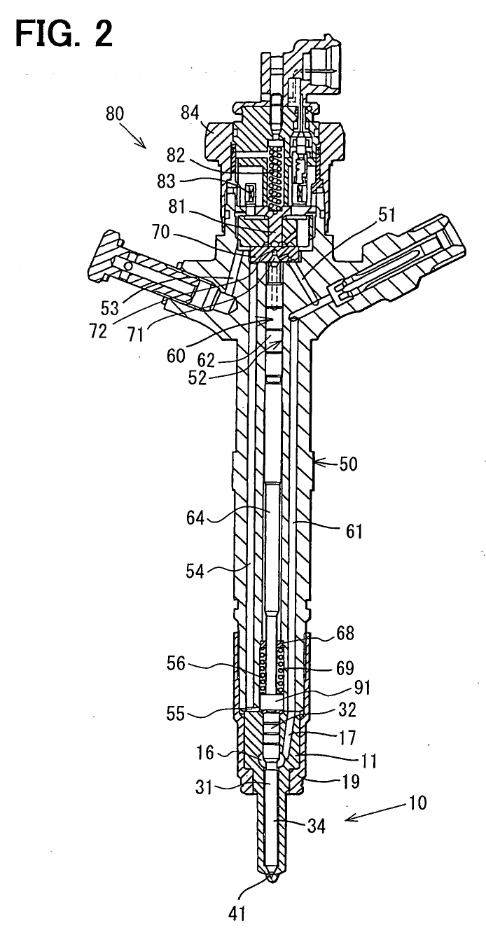

FIG. 2 depicts an entire structure of a fuel injector according to a first embodiment of the present invention. In general, the fuel injector includes a nozzle portion 10, a nozzle holder 50, a control piston 60, a pressure control chamber 71, an electromagnetic valve 80 and a limiter 91. A retaining nut 19 fastens the nozzle portion 10 to a head-side portion of the nozzle holder 50. The fuel injector is for injecting high-pressure fuel, which is supplied from a common rail (not shown), into a combustion chamber of a diesel engine.

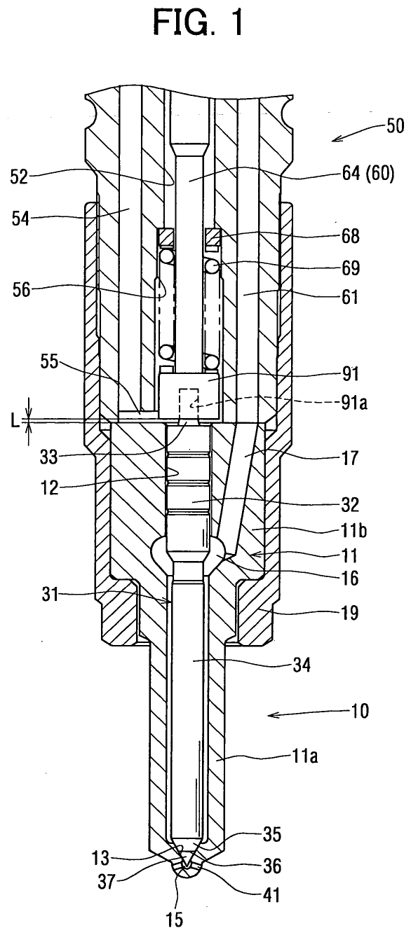

FIG. 1 depicts a nozzle portion 10 of the fuel injector of FIG. 2. As shown in FIGS. 1 and 2, the nozzle portion 10 has a nozzle body 11 containing a needle 31. The needle 31 is slidably disposed in the nozzle body 11 for longitudinal reciprocation.

The nozzle body 11 is generally cylindrical and defines a guide bore 12, a valve seat 13, injection holes 41 and a sack 15. The guide bore 12 extends in the longitudinal direction of the nozzle body 11 so that one end thereof communicates with the valve seat 13 and the opposite end opens on a tail-side end face of the nozzle body 11. The guide bore 12 has a generally uniform internal diameter.

The valve seat 13 has a generally conical surface. An upper end of the valve seat 13 has a larger internal diameter than a lower end and communicates with the guide bore 12. The lower end with the smaller internal diameter communicates with the sack 15. The needle 31 has a contact portion 36 at a head-side end thereof that is arranged for engaging and disengaging the valve seat 13, thereby serving as a valve head. The contact portion 36 is desirably substantially circular.

The sack 15 is located at the head-side end portion of the nozzle body 11. The sack 15 is a chamber having a relatively small volume for accumulating high-pressure fuel to be injected into a combustion chamber. The injection holes 41 are small-diameter passages communicating between the sack 15 and space outside of the nozzle body 11 such as a combustion chamber of an internal combustion engine.

The nozzle body 11 also defines a fuel accumulation chamber 16 located midway along the longitudinal dimension of the guide bore 12. The fuel accumulation chamber 16 includes an annular concavity surrounding and communicating with the guide bore 12. The fuel accumulation chamber 16 also communicates with a first fuel passage 17 defined by the nozzle body 11, through which high-pressure fuel is supplied.

The nozzle body 11 is segmented into a stem portion 11a and an attachment portion 11b. The stem portion 11a has an outer diameter smaller than that of the attachment portion 11b, as shown in FIG. 1. The needle 31 has a thick portion 32 at a tail-side thereof and a thin portion 34 at a head-side thereof, as shown in FIG. 1. The stem portion 11a of the nozzle body 11 contains the thin portion 34 of the needle 31 and defines the valve seat 13, the sack 15, and the injection holes 41. The attachment portion 11b of the nozzle body 11 contains the thick portion 32 of the needle 31 and defines the fuel accumulation chamber 16 and the first fuel passage 17. The retaining nut 19 fastens the nozzle body 11 to the nozzle holder 50.

The needle further has a pin 33, a head base 35 and a conical portion 37. The thick portion 32 of the needle 32 has a generally uniform outer diameter and is slidably supported in the guide bore 12 defining a slight clearance therebetween. The clearance enables a smooth sliding motion of the needle 31 in the guide bore 12. The thin portion 34 of the needle 31 and the guide bore 12 also define a clearance therebetween in which high-pressure fuel flows from the fuel accumulation chamber 16 to the sack 15.

The head base 35 of the needle 31 is disposed between the head-side end of the thin portion 34 of the needle 31 and the conical portion 37 of the needle 31. A circumferential face on which the head base 35 and the conical portion 37 contact each other constitutes the contact portion 36 of the needle 31.

The conical portion 37 of the needle 31 is steeper than the face of the valve seat 13. This allows the contact portion 36 to securely and sealingly engage the valve seat 13. The head-side end of the conical portion 37 faces the sack 15 when the contact portion 36 engages the valve seat 13. The valve seat 13 and the contact portion 36 provide a nozzle seal for sealing high-pressure fuel.

The thick portion 32 of the needle 31 includes a first slide portion, which longitudinally reciprocates within the guide bore 12 of the nozzle body 11. The thin portion 34, the head base 35, and the conical portion 37 of the needle 31 define a first insert portion. The first insert portion has a diameter that is smaller than a diameter of the first slide portion. The thick portion 32 and the thin portion 34 are connected by a tapered portion. The tapered portion has a circumference that inclines along the longitudinal direction of the nozzle body 11. The tapered portion receives the pressure of fuel in the fuel accumulation chamber 16. High-pressure fuel in the fuel accumulation chamber 16 urges the tapered portion toward the tail-side end of the nozzle body 11 (upward in the FIGS.), so as to move the needle 31 and lift the contact portion 36 off of the valve seat 13. The first insert portion 34, 35 and 37 is surrounded by the fuel accumulation chamber 16.

As shown in FIG. 2, the nozzle holder 50 defines a second fuel passage 51, a cylindrical bore 52, a first discharge passage 53, and a third fuel passage 61. High-pressure fuel supplied from the common rail flows via the second fuel passage 51 to an orifice plate 70 and via the third fuel passage 61 to the first fuel passage 17 in the nozzle portion 10. The first discharge passage 53 returns high-pressure fuel toward a low-pressure side of the injector such as to a fuel tank. The cylindrical bore 52 contains a second insert portion 64 forming a head-side portion of the control piston 60.

A room 56 defined between the cylindrical bore 52 and the second insert portion 64 of the control piston 60 constitutes a back-pressure chamber for the needle 31. This room 56 communicates with fuel discharge passages 54 and 55, which are connected to the first discharge passage 53 and returns the high-pressure fuel to the low-pressure side.

The cylindrical bore 52 slidably contains the control piston 60 and the limiter 91. The limiter 91 connects the needle 31 to the control piston 60. The control piston 60 has a second slide portion 62 disposed at the tail-side portion thereof. The second insert portion 64 has a smaller diameter than that of the second slide portion 62. The second slide portion 62 and the second insert portion 64 longitudinally reciprocate within the cylindrical bore 52.

The pin 33 at the end of the needle 31 and the control piston 60 contain the limiter 91 therebetween. A spring 69 located in the room 56 around the control piston 60 biases the needle 31 toward the head-side of the nozzle portion 10 to bias the contact portion 36 into engagement with the valve seat 13. The limiter 91 is generally cylindrical and has a concavity 91a on a head-side end face thereof, into which the pin 33 provided at the tail-side end of the needle 31 is disposed. A tail-side end face of the limiter 91 contacts the head-side face of the second insert portion 64 of the control piston 60.

The limiter 91 is arranged to slide together with the needle 31 and the control piston 60. A clearance L separates the head-side end face of the limiter 91 and a tail-side end face of the stem portion 11a of the nozzle body 11. The clearance L is set to a predetermined length L₀, which can decrease by the assembly of the nozzle body 11 and the needle 31.

During operation of the fuel injector, the pressure control chamber 71 accumulates fuel at a predetermined pressure. The pressurized fuel in the pressure control chamber 71 actuates the control piston 60 to push the needle 31 into engagement with the valve seat 13 of the nozzle body 11. This eliminates the clearance L between the limiter 91 and the stem portion 11a of the body 11.

The clearance L is eliminated due to an elastic elongation of the stem portion 11a of the nozzle body 11 that is caused by a compressive stress between the contact portion 36 of the needle 31 and the valve seat 13. It should be appreciated that the attachment portion 11b of the nozzle body 11 experiences no elastic deformation.

The orifice plate 70 is located at the upper end portion of the nozzle holder 50 where the cylindrical bore 52 opens. The orifice plate 70 defines the pressure control chamber 71 that communicates with the cylindrical bore 52.

The orifice plate 70 has an entry orifice (not shown) and an exit orifice 72 located upstream and downstream of the pressure control chamber 71, respectively. The exit orifice 72 has an internal diameter larger than that of the entry orifice.

The entry orifice is located between the second fuel passage 51 and the pressure control chamber 71. The exit of the entry orifice opens on a tapered side face of the pressure control chamber 71. The exit orifice 72 is located at the tail-side of the pressure control chamber 71 and in communication with the first discharge passage 53 via the electromagnetic valve 80. The pressure control chamber 71 is supplied with high-pressure fuel via the second fuel passage 51 located in the nozzle holder 50.

The electromagnetic valve 80 has an armature 81, a spring 82 and a solenoid 83. The armature 81 connects and interrupts a communication between the exit orifice 72 and the first discharge passage 53. The spring 82 urges the armature 81 in a direction to close the electromagnetic valve 80 (downward in FIGS. 1 and 2). The solenoid 83 actuates the armature 81 in a direction to open the electromagnetic valve 80. The electromagnetic valve 80 is installed at the tail-side of the nozzle holder 50 and sandwiches the orifice plate 70 therebetween. A retaining nut 84 fastens the electromagnetic valve 80 to the nozzle holder 50. A current flowing into the solenoid 83 opens the exit orifice 72 by lifting up the armature 81 against the restitutive force of the spring 82. Interrupting the current flowing into the solenoid 83 closes the exit orifice 72 by pushing the armature 81 with the restitutive force of the spring 82.

The pressure control chamber 71 and the electromagnetic valve 80 actuate the control piston 60 to directly or indirectly move the needle 31 to cause the contact portion 36 to engage the valve seat 13.

The operation of the fuel injector is as follows.

High-pressure fuel supplied from the common rail to the fuel injector flows via the third fuel passage 61 into the first fuel passage 17 in the nozzle portion 10 and via the second fuel passage 51 into the pressure control chamber 71. When the electromagnetic valve 80 is closed, that is, when the armature 81 closes the exit orifice 72, pressurized fuel in the pressure control chamber 71 acts on the needle 31 via the control piston 60 and the pin 31 in a direction to seat the contact portion 36 onto the valve seat 13 together with the restitutive force of the spring 69.

High-pressure fuel in the first fuel passage 17 flows into the fuel accumulation chamber 16 and acts on the tapered portion of the needle 31 in a direction to lift the contact portion 36 off of the valve seat 13.

When the electromagnetic valve 80 is closed, the force to seat the contact portion 36 exceeds that to lift the contact portion 36 and the contact portion 36 of the needle 31 maintains engaged with the valve seat 13 of the nozzle body 11. Thus, fuel is not injected through the injection holes 41.

When the electromagnetic valve 80 opens, that is, when the armature 81 opens the exit orifice 72, the exit orifice 72 communicates with the first discharge passage 53 in the nozzle holder 50. Thus, high-pressure fuel in the pressure control chamber 71 flows via the exit orifice 72 and is discharged by the first discharge passage 53. Furthermore, high-pressure fuel continues to flow via the entry orifice into the pressure control chamber 71. However, the diameter of the entry orifice is smaller than that of the exit orifice 72, thus, the pressure in the pressure control chamber 71 acting on the command piston 60 gradually decreases. Thus, balancing the pressure of fuel in the pressure control chamber 71, the force to lift the contact portion 36 of the needle 31 off the valve seat 13, and the restitutive force of the spring 69. When the force generated to lift the needle 31 exceeds that to seat the needle 31, the contact portion 36 of the needle 31 disengages the valve seat 13 to open the injection holes 41. Thus, fuel is injected through the injection holes 41. The lift height of the needle 31 corresponds to the clearance between the valve seat 13 and the contact portion 36.

By interrupting the current flow to the solenoid 83, the armature 81 closes the exit orifice 72 so that the pressure of fuel in the pressure control chamber 71 increases and urges contact portion 36 of the needle 31 to engage the valve seat 13. When the force to seat the contact portion 36 exceeds that to lift the contact portion 36, the contact portion 36 of the needle 31 engages the valve seat 13 of the nozzle body 11 and fuel ceases to inject through the injection holes 41.

When the contact portion 36 of the needle 31 engages the valve seat 13, the electromagnetic valve 80 is closed to interrupt the communication with the first discharge passage 53. This causes the pressure of fuel in the pressure control chamber 71 to increase up to the same level of that of the high-pressure fuel supplied to the fuel accumulation chamber 16 in the nozzle portion 10.

When the needle 31 engages the valve seat 13, each of the pressure control chamber 71 and the fuel accumulation chamber 16 are filled with high-pressure fuel supplied from the common rail. High-pressure fuel in the pressure control chamber 71 generates a driving force to push the control piston 60. The driving force presses the contact portion 36 of the needle 31 via the control piston 60 into engagement with the valve seat 13 of the nozzle body 11.

Thus, the contact portion 36 is compressed onto the valve seat 13, generating an elastic elongation of the stem portion 11a of the nozzle body 11. Then, the predetermined level of fuel pressure in the pressure control chamber 71 continues to apply the driving force until the elastic elongation reaches the length L₀. At this time, the clearance L between the head-side end face of the limiter 91 and a tail-side end face of the attachment portion 11b of the nozzle body 11 decreases to zero and the limiter 91 engages the attachment portion 11b of the nozzle body 11. Thus, the driving force generated by the high-pressure fuel in the pressure control chamber 71 is dispersed by the head-side end face of the limiter 91 and the attachment portion 11b of the nozzle body 11, thereby reducing the amount of concentration of the driving force on the valve seat 13 of the nozzle body 11 an the contact portion 36 of the needle 31.

The limiter 91 and the attachment portion 11b of the nozzle body 11 form a force disperser of the present invention. Together, the limiter 91 and the attachment portion 11b serve to disperse the driving force to other portions of the fuel injector other than the valve seat 13 and the contact portion 36 when the elastic elongation of the stem portion 11a reaches the predetermined length L₀.

The above-described driving force exceeds a minimum force required to force the contact portion 36 into engagement with the valve seat 13. Thus, the present invention prevents the excessive force from damaging the contact portion 36 of the needle and/or the valve seat 13 of the nozzle body 11.

The advantages of the fuel injector according to the first embodiment are as follows.

First, while the needle 31 is seated on the valve seat 13 of the nozzle body 11, if the displacement of the needle 31 relative to the nozzle body 11 exceeds a predetermined length L₀, the force disperser 11 91 disperses the driving force generated in the pressure control chamber 71 to prevent it from being concentrated on the valve seat 13 and the contact portion 36. Thus, if the elastic deformation in accordance with the driving force of the predetermined strength occurs, the fuel injector disperses the driving force of excessive strength by the force disperser 11, 91 thereof not to concentrate on the valve seat 13 and the contact portion 36.

Second, the clearance L between the limiter 91 and the attachment portion 11b of the nozzle body 11 is set to a predetermined length L₀. During operation of the fuel injector, when the needle 31 is seated on the valve seat 13 of the nozzle body 11 and when the elastic displacement L₀ in accordance with the driving force of the predetermined strength occurs, the clearance L decreases to zero and the limiter 91 engages the attachment portion 11b of the nozzle body 11. Thus, the driving force is not concentrated on the valve seat 13 and the contact portion 36, and is dispersed by the contact faces of the limiter 91 and the attachment 11b.

Third, this embodiment is suitable for a fuel injector having a pressure control chamber 71, an electromagnetic valve 80 for increasing and decreasing the pressure of fuel in the pressure control chamber 71, and a control piston 60 that receives the pressure of fuel in the pressure control chamber 71 at a end thereof opposite to another end facing the needle 31. Thus, the driving force generated by the pressure of fuel in the pressure control chamber 71 may exceed a predetermined strength causing elastic deformation of the predetermined length L₀. That is, the pressure of fuel can be set to a high level to inject the fuel through injection hole 41 at a high pressure.

Fourth, the fuel injector of the above-described embodiment can prevent an excessive driving force generated in the driving force generator such as the pressure control chamber 71 from being concentrated on the valve seat 13 of the nozzle body 11 and the contact portion 36 of the needle 31. Thus, the fuel injector can reduce the wear of the valve seat 13 and the contact portion 36 so as to reduce variations in the fuel injection amount.

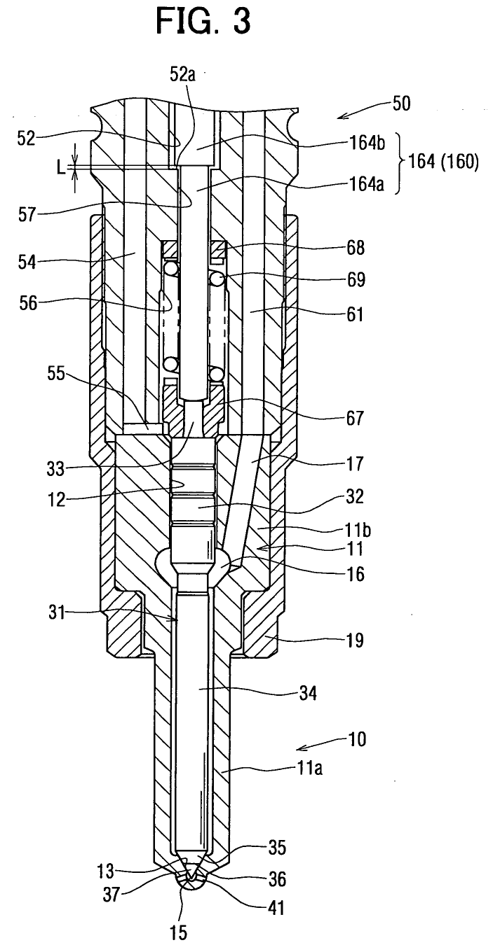

With reference to FIG. 3, a fuel injector according to a second embodiment of the present invention includes a force disperser including a nozzle holder 50 and a control piston 160.

The control piston 160 has a slide portion slidably supported by a cylindrical bore 52 and an insert portion 164 having a diameter that is smaller than that of the slide portion. The insert portion 164 includes a thick portion 164b and a thin portion 164a having a diameter that is smaller than that of the thick portion 164b. The cylindrical bore 52 has a narrow portion 57 having an internal diameter that is smaller than that of other portions of the bore 52 and larger than that of the thin portion 164a of the control piston 160.

A boundary of the narrow portion 57 of the cylindrical bore 52 forms a step 52a. A boundary between the thick portion 164b and the thin portion 164a of the insert portion 164 of the control piston 160 forms a stopper. An axial clearance L exists between the step 52a and the stopper. During operation, pressurized fuel in a pressure control chamber 71 (similar to that described above in accordance with the first embodiment) applies a driving force to the control piston 160 for pushing a needle 31 onto a valve seat 13. This causes the clearance L to decrease to zero due to an elastic deformation of a stem portion 11a of the nozzle body 11 and the needle 31, similar to that described above in accordance with the first embodiment.

When the clearance L decreases to zero, the stopper of the control piston 160 engages the step 52a of the nozzle holder 50 and disperses the driving force, thereby reducing an amount it concentrates on the valve seat 13 of the nozzle body 11 and the contact portion 36 of the needle 31.

It should therefore be appreciated that the fuel injector according to the second embodiment has advantages equivalent to those of the fuel injector according to the first embodiment.

In the first and the second embodiments, the fuel pressure in the pressure control chamber 71 applies a driving force to the control piston 60, 160. In the present invention, the power source for actuating the control piston is not limited to the above-described pressure control chamber 71, which increases and decreases the pressure of fuel therein by opening and closing the electromagnetic valve 80. It should be appreciated that the present invention may alternatively include a power source such as a pressure generator or a displacement generator, which magnifies a displacement of a piezoelectric stack by an action of lever to actuate the control piston.

In the second embodiment, the step 52a of the nozzle holder 50 and the stopper in the slide portion 164 of the control piston 160 forms the force disperser. In an alternative embodiment, the force disperser may be formed by a different portion of the control piston 160 (60), for example, in a second slide portion 62 (refer to FIG. 2).

1. A fuel injector for an internal combustion engine comprising:
a nozzle body having a valve seat;
a needle slidably installed in the nozzle body and having a valve head for engaging the valve seat;
a control piston for transmitting a drive force to the needle; and
a force disperser that disperses the drive force when the the needle displaces a predetermined distance relative to the nozzle body, the force disperser providing an elastic deformation of at least one of the nozzle body and the needle to reduce concentration of the drive force on the valve seat and the valve head.

2. The fuel injector according to claim 1,
wherein the force disperser includes a stopper located between and movable together with the needle and the control piston, the stopper engaging the nozzle body when the needle displaces the predetermined distance relative to the nozzle body.

3. The fuel injector according to claim 1, wherein the force disperser includes:
a stopper located at a mid-portion of the control piston; and
a tube slidably supporting the control piston therein and shaped to engage the stopper when the needle displaces the predetermined distance relative to the nozzle body.

4. The fuel injector according to claim 3, wherein:
the tube has a wide bore portion, a bore step, and a narrow bore portion, the narrow bore portion having a diameter smaller than that of the wide bore portion and located between the wide bore portion and the nozzle body, the bore step located at a boundary between the wide bore portion and a narrow bore portion; and
the control piston has a thick portion, the stopper, and a thin portion, the thin portion located between the thick portion and the needle, the thick portion having a diameter larger than that of the narrow bore portion of the tube, the stopper shaped in a step at a boundary between the thick portion and the thin portion.

5. The fuel injector according to claim 1, further comprising:
a drive force generator located on an axial end of the control piston opposite to the needle for applying the drive force to the control piston.

6. The fuel injector according to claim 5,
the drive force generator has a pressure control chamber containing highly-pressurized fuel and an electromagnetic valve for increasing and decreasing the pressure of the fuel for applying the driving force.

7. A fuel injector for an internal combustion engine comprising:
a nozzle housing defining a cylindrical bore, a valve seat, and a first stopper face;
a piston assembly disposed in the cylindrical bore for longitudinal reciprocation and having a second stopper face opposing the first stopper face; and
a drive force generator for transmitting a drive force to the piston assembly such that upon the piston assembly displacing a predetermined distance toward the valve seat the second stopper face engages the first stopper face of the nozzle housing thereby elastically deforming at least a portion of at least one of the nozzle housing and the piston assembly and dispersing the drive force throughout the fuel injector to reduce the concentration of the drive force on the piston assembly and the valve seat.

8. The fuel injector according to claim 7, wherein the piston assembly includes a needle, a control piston, and a limiter disposed therebetween defining the second stopper face.

9. The fuel injector according to claim 7, wherein the piston assembly includes a control piston defining the second stopper face at a location approximately midway along its longitudinal dimension.

10. The fuel injector of claim 9, wherein the nozzle assembly includes a tube defining the first stopper face.

11. The fuel injector of claim 7, wherein the drive force generator includes a pressure control chamber containing highly-pressurized fuel and an electromagnetic valve for increasing and decreasing the pressure of the fuel for applying the drive force.
